(19) United States
(12) Patent Application Publication
(10) Pub. No.: US 2025/0319558 A1
(43) Pub. Date: Oct. 16, 2025

(54) CLAMPING RAM AND METHOD FOR PRODUCING A CLAMPING RAM

(71) Applicant: ADELBERT HAAS GMBH, Trossingen (DE)

(72) Inventor: Timo ZEPF, Seitingen-Oberflacht (DE)

(21) Appl. No.: 19/175,532

(22) Filed: Apr. 10, 2025

(30) Foreign Application Priority Data
Apr. 11, 2024 (DE) 102024110182.2

(51) Int. Cl. B23Q 3/06

(52) U.S. Cl. CPC B23Q 3/062; B23Q 2240/002

(57) ABSTRACT

A clamping ram has a shaft with a longitudinal axis, a first end and a second end. At the second end, two arms are arranged which extend in the longitudinal direction and are mutually spaced by a gap. Each of the arms has an inner surface and an outer surface. At a free end of the arms, a radial thickening is provided on each outer surface. Between the two arms, a wedge plate is arranged so as to be movable in the longitudinal direction. In a retracted position of the wedge plate, the arms are in a compressed state and, in an advanced position of the wedge plate, the arms are in a spread state. Each of the two radial thickenings has a contact surface which, in the spread state, are each part of an imaginary surface that is rotationally symmetrical about the longitudinal axis.

The invention relates to a clamping ram and to a method for producing a clamping ram

Machine tools are becoming increasingly automated. This means, in particular, that tool changes during operation of such a machine tool are also carried out partially or fully automatically. It is common practice to connect the various tools to a spindle, a rotary axis or other dividing apparatus of the machine tool via a tool holder.

There are also cases where the workpiece to be machined is coupled to the spindle, the rotary axis or the dividing apparatus. To clarify this, the term “tool or workpiece holder” is used below, although in principle any tool holder is also a workpiece holder or becomes a workpiece holder when the clamping means, in which the tool is intended to be held in the case of a tool holder, is used to hold a workpiece.

It is known to fasten tools or workpieces having an axial hole in the tool or workpiece holder by means of a clamping ram which has at one end in particular an elongate cylindrical shaft having a radial thickening which can be, for example, conical, convex or cylindrical. For this purpose, the clamping ram is guided through the hole, and the cylindrical shaft of the clamping ram is gripped in a chuck of the tool or workpiece holder and is retracted axially to such an extent that the tool or workpiece rests against an end face of the tool or workpiece holder and is held clamped between the end face of the tool or workpiece holder and the thickening of the clamping ram.

Changing the tool or workpiece is complex: Either the tool or workpiece has to be held by means of a separate handling unit, while the clamping ram has to be pulled out of the hole in the tool or workpiece by means of a further handling unit, for which purpose, on the side of the thickening facing away from the shaft, a projection has to be provided at which the handling unit can grip the clamping ram. Alternatively, the tool or workpiece has to be pulled out of the tool or workpiece holder together with the clamping ram by means of a handling unit in order to reinsert a different tool or workpiece together with a different clamping ram, which both increases the feed paths and the number of handling steps and requires a larger number of clamping rams to be kept available.

Therefore, it is already known to fix a clamping ram that is divided in the axial direction, starting from the end of the clamping ram that has the thickening, in the chuck of the tool or workpiece holder. The divided clamping ram is designed in such a way that the two arms of the clamping ram, in a compressed state, have an outer diameter such that the thickening can be guided through the hole in the tool or workpiece. The two arms are then spread apart, for example by a wedge plate, so that the outer diameter of the thickening is increased in such a way that the tool or workpiece can be clampingly fixed between the thickening and the end face of the tool or workpiece holder. With a clamping ram divided in this way, the tool or workpiece can be placed on the clamping ram when the divided clamping ram is in the compressed state, without the clamping ram having to be removed from the chuck. The disadvantage of the known divided clamping rams is that, since they are manufactured in the compressed state with subsequent spreading of the arms, they rest on the inner surface of the hole only at certain points after spreading. This creates large tolerances, which result in manufacturing inaccuracies.

The object of the invention is therefore to provide a clamping ram with which the accuracy of the positioning of a tool or workpiece in the tool or workpiece holder can be improved. Furthermore, a method for producing a clamping ram is to be provided, by means of which a clamping ram can be manufactured which can enable positioning of a tool or workpiece in the tool or workpiece holder with improved accuracy.

The object is achieved according to the invention by a clamping ram having the features of claim 1 and a method for producing a clamping ram having the features of claim 11.

Advantageous embodiments and developments of the invention are specified in the dependent claims.

The clamping ram according to the invention having a shaft with a longitudinal axis, a first end and a second end, wherein at the second end two arms are arranged which extend in the longitudinal direction and are mutually spaced by a gap, wherein each of the arms has an inner surface and an outer surface, and wherein, at a free end of the arms, a radial thickening which can be, for example, conical, convex or cylindrical, is provided on each outer surface, wherein between the two arms a wedge plate is arranged so as to be movable relative to the two arms in the longitudinal direction, wherein, in a retracted position of the wedge plate, the arms are in a compressed state and, in an advanced position of the wedge plate, the arms are in a spread state, is characterized in that each of the two radial thickenings has a contact surface which, in the spread state, are each part of an imaginary surface that is rotationally symmetrical about the longitudinal axis. Such a design ensures that the contact surface in a hole in a tool or workpiece to be fastened rests against the inner surface of the hole not only at certain points, but at least along a linear contact surface, since the contact surfaces are part of a rotationally symmetrical imaginary surface which rests against the rotationally symmetrical inner surface of the hole.

It is possible to move the wedge plate while the arms are stationary in order to transfer the arms from the compressed state to the spread state. Alternatively, the clamping ram can be moved against a stationary wedge plate in order to transfer the arms from the compressed state to the spread state. It is essential that a relative movement between the wedge plate, on the one hand, and the arms, on the other hand, allows a change between the compressed state and the spread state of the arms.

According to a particularly preferred development of the invention, the radial thickenings widen conically toward the free end of the arms at least over an axial portion. By adapting the cone angle to the angle of a countersink in the hole in the workpiece or tool to be fastened, it is even possible to achieve a flat contact surface between the clamping ram, in particular the contact surfaces of its thickenings, and the hole in the tool or workpiece to be fastened.

Preferably, the contact surfaces are curved. Such a design can enable at least one linear contact surface in a countersink in a tool or workpiece to be fastened, even in the case of different inclinations.

Preferably, each of the outer surfaces in at least one cross-section is in the form of a circular arc portion with a radius R, wherein, in the spread state, the two circular arc portions lie on an imaginary circle with the radius of the circular arc portions of this cross-section around the longitudinal axis. In other words, an outer contour surrounding the arms is round in at least one cross-section when in the spread state. Such a design allows a linear contact surface to be created in a conical countersink.

Advantageously, each of the outer surfaces in any cross-section between the free end of the arms and the second end of the shaft is in the form of a circular arc portion with a radius R, wherein, in the spread state, the two circular arc portions lie on an imaginary circle with the radius of the circular arc portions of this cross-section around the longitudinal axis. It should be noted that the radius R does not have to be the same for every cross-section. In particular, the radius R is larger in the region of the thickenings than in the region outside the thickenings. In other words, this design is a clamping ram which, in the spread state, can be circumscribed by a rotationally symmetrical outer contour.

In a preferred embodiment, each of the arms can have on its outer side an auxiliary surface at the end remote from the free end. These auxiliary surfaces are advantageous for the process of pressing together or compressing the arms into the compressed state. By deliberately weakening the arms using these auxiliary surfaces, it is possible to deliberately influence how the arms deform.

According to a preferred development of the invention, the wedge plate is detachable. This allows a wedge plate of suitable length to be selected according to the thickness of the tool or workpiece to be fastened, both in order to prevent the wedge plate, in the spread state, from protruding beyond the tool or workpiece, and to be able to exert a uniform force across the entire thickness of the tool or workpiece.

A clamping ram as described above is preferably used in a set comprising a tool or workpiece having a hole with a minimum inner diameter, wherein, in the compressed state, the arms have in the region of the thickenings an outer diameter which is smaller than the minimum inner diameter, and wherein, in the spread state, the arms have in the region of the thickenings an outer diameter which is larger than the minimum inner diameter. This design makes it possible for the tool or workpiece to be pushed onto the clamping ram via the arms having the thickenings when the clamping ram is in the compressed state. The clamping ram can then be transferred to the spread state so that the tool or workpiece can be held in place by the thickenings on the tool or workpiece holder.

The method according to the invention for producing a clamping ram having a shaft with a longitudinal axis, a first end, and a second end, wherein at the second end two arms are arranged which extend in the longitudinal direction and are mutually spaced by a gap, wherein each of the arms has an inner surface and an outer surface, and wherein at a free end of the arms a radial thickening is provided on each outer surface, wherein between the two arms a wedge plate is arranged so as to be movable in the longitudinal direction, wherein, in a retracted position of the wedge plate, the arms are in a compressed state and, in an advanced position of the wedge plate, the arms are in a spread state, has the following steps:
providing a clamping ram blank,
producing the outer surface of the arms and the thickenings with the arms in the spread state,
introducing the gap between the arms and
transferring the arms into the compressed state.

The invention is based on the finding that if the clamping ram is manufactured in the state in which it ultimately contacts an inner contour of a hole in a tool or workpiece to be fastened, i.e., in the spread state of the arms of the clamping ram, an improved contact surface can be provided, since in this case not only an approximately rotationally symmetrical body can be produced, as in the case of manufacture in the compressed state and subsequent spreading, but an actually rotationally symmetrical body can be produced. The outer surface of the arms and the thickenings can be produced in particular using cylindrical grinding or lathe machining.

According to an advantageous development of the invention, the arms are transferred into the compressed state by pressing or compressing. This makes it easy to deliberately compress the arms.

The gap between the arms is preferably introduced using wire cutting or a material-removing method such as milling or water jet cutting. This allows the gap to be produced with a high degree of precision.

Advantageously, the arms are hardened. This can improve the stability of the clamping ram.

The invention is explained in detail with reference to the following figures, in which

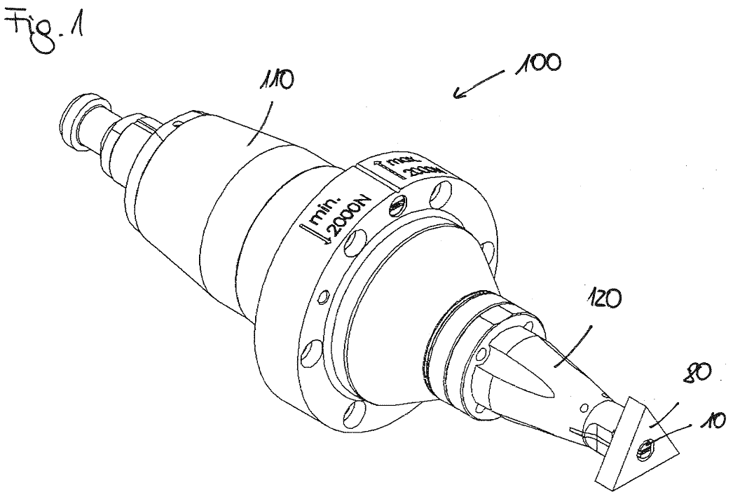

FIG. 1 is a perspective view of an exemplary embodiment of an expanding-mandrel clamping system having a base part, an interchangeable part, a clamping ram and a tool or workpiece;

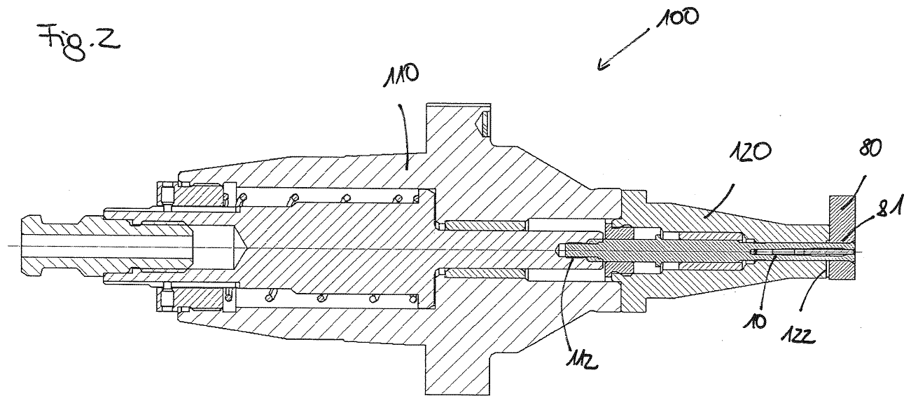

FIG. 2 is a longitudinal section through the expanding-mandrel clamping system according to FIG. 1;

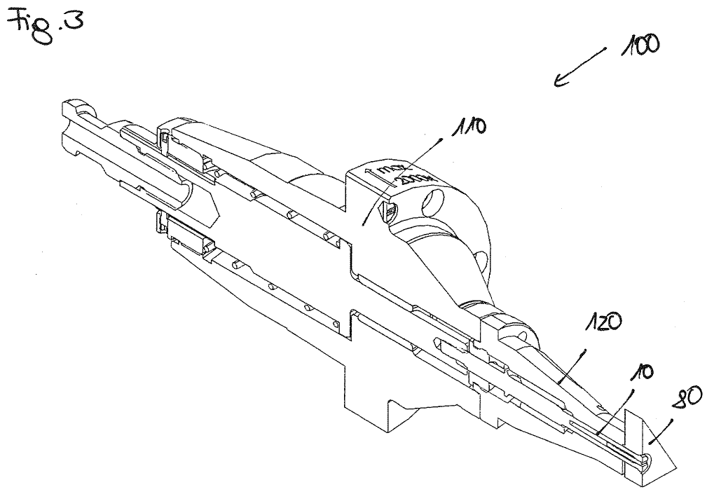

FIG. 3 is a partially sectioned perspective view of the expanding-mandrel clamping system according to FIG. 1;

FIG. 4 is an enlarged detail from FIG. 3;

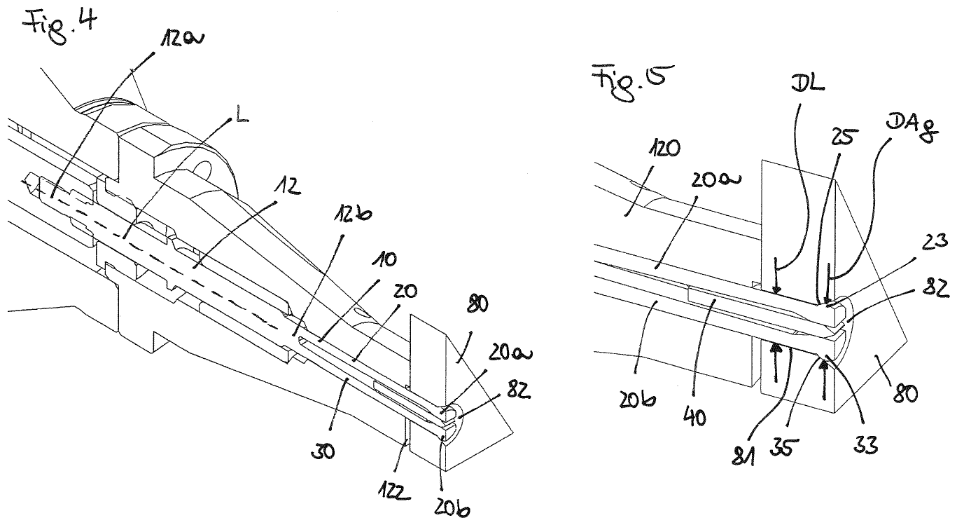

FIG. 5 is an enlarged detail from FIG. 4;

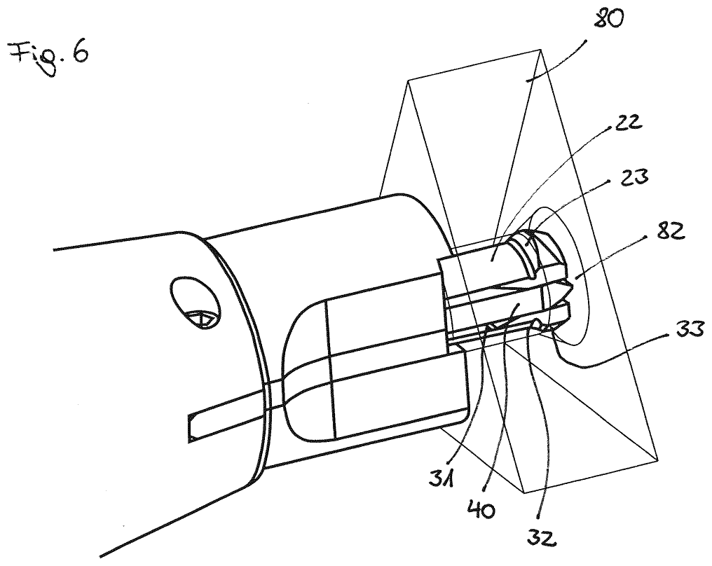

FIG. 6 is an enlarged perspective transparent view of the tool or workpiece held in the spread state by the clamping ram of the expanding-mandrel clamping system according to FIG. 1;

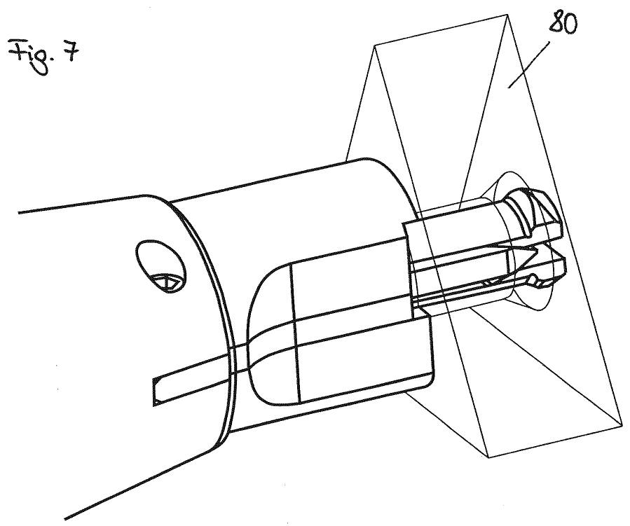

FIG. 7 is a further enlarged perspective transparent view of the tool or workpiece held in the spread state by the clamping ram of the expanding-mandrel clamping system according to FIG. 1;

FIG. 8 is a further enlarged perspective transparent view of the tool or workpiece held in the spread state by the clamping ram of the expanding-mandrel clamping system according to FIG. 1;

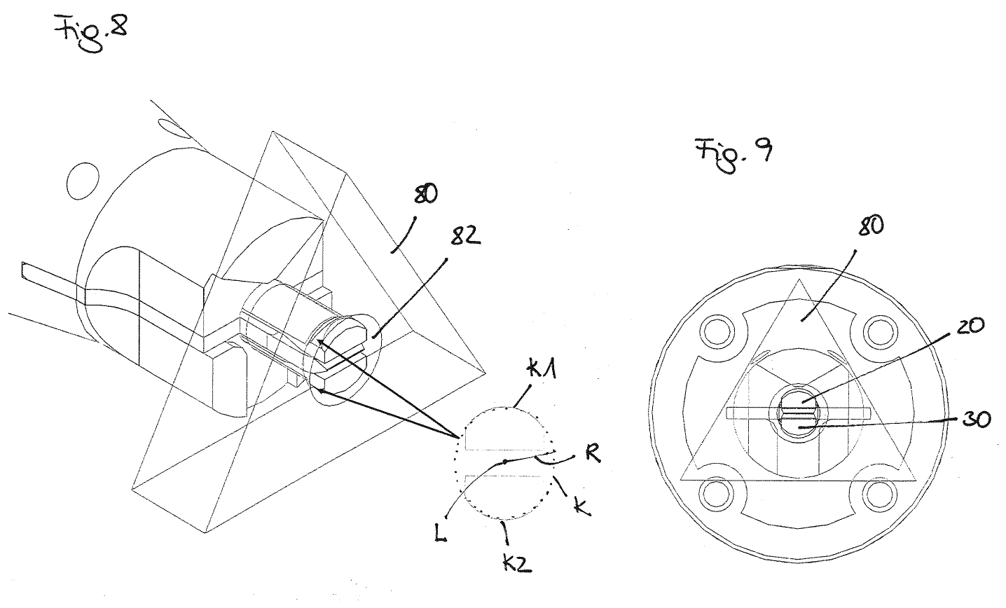

FIG. 9 is a view from the front of the tool or workpiece held in the spread state by the clamping ram of the expanding-mandrel clamping system according to FIG. 1;

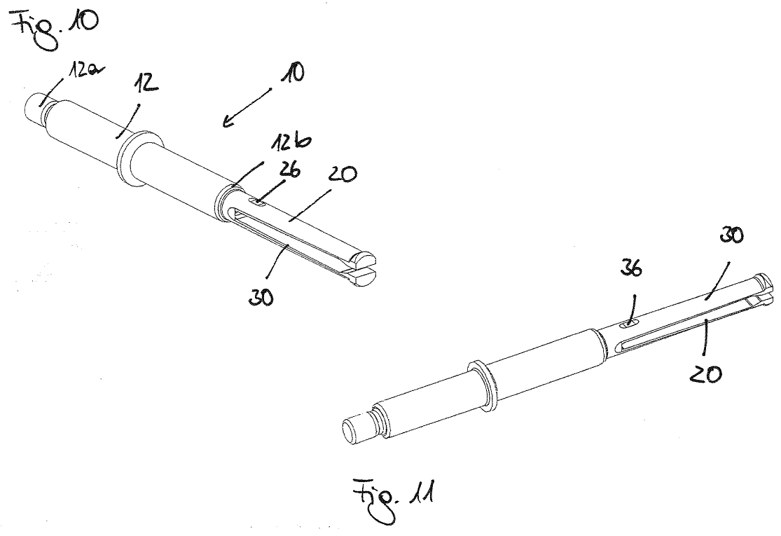

FIG. 10 is a perspective view of the clamping ram of the expanding-mandrel clamping system according to FIG. 1 in the expanded state;

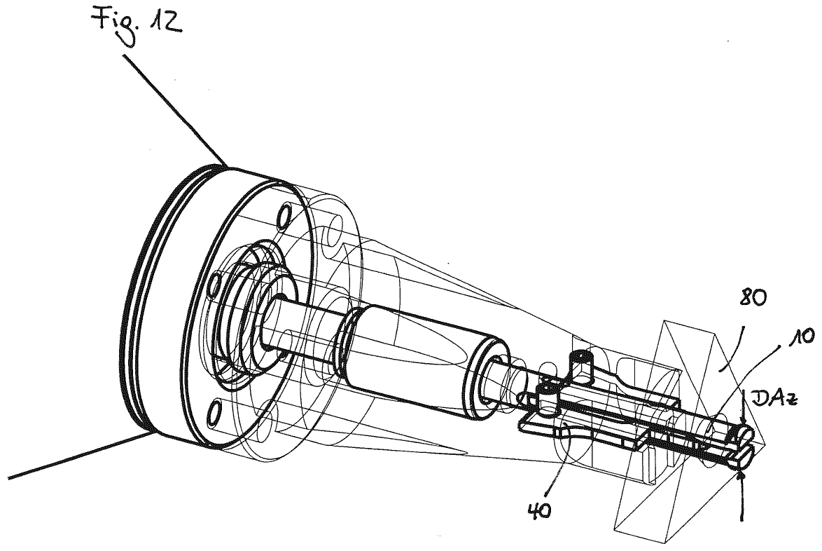

FIG. 11 is a further perspective view of the clamping ram of the expanding-mandrel clamping system according to FIG. 1 in the expanded state; and

FIG. 12 is a transparent perspective view of the expanding-mandrel clamping system according to FIG. 1 with the clamping ram in the compressed state.

FIGS. 1 to 12 show various views of an exemplary embodiment of an expanding-mandrel clamping system 100 for clampingly fixing a tool or workpiece 80 or parts thereof, in particular a clamping ram 10.

The clamping ram 10, which can be seen in particular in FIGS. 10 and 11, has a cylindrical, elongate shaft 12 with a longitudinal axis L, a first end 12a and a second end 12b. The first end 12a can have an interface to a pull-type fastening mechanism 112, which can be arranged in a base part 110 of the expanding-mandrel clamping system 100 (cf. in particular FIGS. 2 and 3), which can be in the form, for example, of a screw connection, collet or bayonet closure. At the second end 12b, two arms 20, 30 are arranged which extend in the longitudinal direction, i.e., parallel to the longitudinal axis L, and are mutually spaced by a gap 14. Each of the arms 20, 30 therefore has a free end 20a, 30b, which is situated at the end of the arm 20, 30 remote from the shaft 12. Each of the arms 20, 30 also has an inner surface 21, 31 facing the other arm 30, 20 and an outer surface 22, 32 facing away from the other arm 30, 20. On each of the arms 20, 30, at the free end 20a, 30b on the outer side 22, 32, a radial thickening 23, 33 is provided which together can be designed in the manner of a head of a screw or a nail. The radial thickening 23, 33 can, for example, be conical, convex or cylindrical or be designed as part thereof.

Between the two arms 20, 30, a wedge plate 40 is arranged so as to be displaceable in the longitudinal direction relative to the two arms 20, 30, wherein, in a retracted position of the wedge plate 40, the arms 20, 30 are in a compressed state (cf. FIG. 12) and, in an advanced position of the wedge plate 40, the arms 20, 30 are in a spread state (cf. in particular FIGS. 2 and 5 to 9). The wedge plate 40 can in this case be detachable. The wedge plate 40 can be arranged in a stationary manner, it being possible for the clamping ram 10 to be retracted parallel to its longitudinal axis L by means of the pull-type fastening mechanism 112 in order to bring the wedge plate 40 into the advanced position in which the arms 20, 30 are arranged in the spread state. Such a two-part clamping ram 10 with the movable wedge plate 40 is also referred to as an expanding mandrel.

With the clamping ram 10, a tool or workpiece 80 having a hole 81 can be fastened to a tool or workpiece holder 122 of an interchangeable part 120 of the expanding-mandrel clamping system. The hole 80 has 81 a minimum inner diameter DL, which is formed by the smallest diameter of the hole 81. The clamping ram 10 and the tool or workpiece 80 are adapted to one another in such a way that, in the compressed state, the arms 20, 30 have in the region of the thickenings 23, 33 an outer diameter DAz which is smaller than the minimum inner diameter DL, and that, in the spread state, the arms 20, 30 have in the region of the thickenings 23, 33 an outer diameter Dag which is larger than the minimum inner diameter DL. This makes it possible for the hole 81 to be guided over the clamping ram 10 when the clamping ram 10 is in the compressed state. Subsequently, the clamping ram 10 is transferred to the spread state, in particular by pushing the wedge plate 40 forward into the advanced position, so that the outer diameter increases in the region of the thickenings 23, 33. The clamping ram 10 can be fastened in the base part 110 using the pull-type fastening mechanism 122, wherein, in particular by pulling said mechanism into the tool or workpiece holder 122 it is possible to clampingly fix the tool or workpiece 80, wherein in particular the thickenings 23, 33 come into contact with the tool or workpiece 80, in particular with an inner surface of a countersink 82 in the hole 81.

Each of the two radial thickenings 23, 33 has a contact surface 24, 34 which, in the spread state, are each part of an imaginary surface that is rotationally symmetrical about the longitudinal axis L. The radial thickenings 23, 33 can, for example, widen conically toward the free end 20a, 30a of the arms 20, 30 at least over an axial portion 25, 35. As can be seen, for example, in FIG. 6, the two contact surfaces 24, 34 can lie on a conical, rotationally symmetrical surface which, in FIG. 6, substantially corresponds to an inner surface of the conical countersink 82. This allows an at least linear contact between the two contact surfaces 24, 34 and the inner surface of the hole 81, in particular the countersink 82, and also a planar contact if the angle of inclination of the contact surfaces 24, 34 is adapted to the angle of inclination of the countersink 82.

Each of the outer surfaces 22, 32 can in at least one cross-section be in the form of a circular arc portion K1, K2 with a radius R, wherein, in the spread state, the two circular arc portions K1, K2 lie on an imaginary circle K with the radius R of the circular arc portions K1, K2 of this cross-section around the longitudinal axis L (cf. FIG. 8). Preferably, this applies to any cross-section between the free end 20a, 30a of the arms 20, 30 and the second end 12b of the shaft 12.

The clamping ram 10 is usually made of metal.

The clamping ram 10 can be produced as follows. First, a clamping ram blank is provided. This is typically a rotationally symmetrical body made of solid material. The clamping ram blank is machined, in particular using cylindrical grinding or lathe machining, in such a way that the outer surfaces of the arms 20, 30, including the thickenings 23, 33 are created. In this way, the outer contour is formed, which corresponds to the arms 20, 30 of the clamping ram 10 in the spread state. The gap 14 is then introduced between the arms 20, 30, for example using wire cutting or a material-removing method such as milling or water jet cutting. Preferably, a hardening process is carried out. If the gap 14 is introduced by wire cutting, this is preferably done after hardening. If the gap 14 is introduced by milling or water jet cutting, hardening preferably takes place after the gap 14 has been introduced between the arms 20, 30.

Finally, the arms 20, 30 are transferred to the compressed state. This can be done, for example, by pressing or compressing. For this purpose, each of the arms 20, 30 can have on its outer side 22, 32, at the end remote facing away from the free end 20a, 30a, an auxiliary surface 26, 36, which can be structured, for example, and with which a device for deforming the arms 20, 30 can engage.

### LIST OF REFERENCE SIGNS

10 Clamping ram
12 Shaft
12a First end
12b Second end
14 Gap
20 Arm
20a Free end
21 Inner surface
22 Outer surface
23 Thickening
24 Contact surface
25 Axial portion
26 Auxiliary surface
30 Arm
30a Free end
31 Inner surface
32 Outer surface
33 Thickening
34 Contact surface
35 Axial portion
36 Auxiliary surface
40 Wedge plate
80 Tool or workpiece
81 Hole
82 Countersink
100 Expanding-mandrel clamping system
110 Base part
112 Pull-type fastening mechanism
120 Interchangeable part
122 Tool or workpiece holder
L Longitudinal axis
K1 Circular arc portion
K2 Circular arc portion
K Circle
R Radius
DAz Outer diameter
DAg Outer diameter
DL Inner diameter

1. A clamping ram (10) having a shaft (12) with a longitudinal axis (L), a first end (12a) and a second end (12b), wherein at the second end (12b) two arms (20, 30) are arranged which extend in the longitudinal direction and are mutually spaced by a gap (14), wherein each of the arms (20, 30) has an inner surface (21, 31) and an outer surface (22, 32), and wherein at a free end (20a, 30a) of the arms (20, 30), a radial thickening (23, 33) is provided on each outer surface (22, 32), wherein between the two arms (20, 30) a wedge plate (40) is arranged so as to be movable relative to the two arms (20, 30) in the longitudinal direction, wherein, in a retracted position of the wedge plate (40), the arms (20, 30) are in a compressed state and, in an advanced position of the wedge plate (40), the arms (20, 30) are in a spread state,
characterized in that each of the two radial thickenings (23, 33) has a contact surface (24, 34) which, in the spread state, are each part of an imaginary surface that is rotationally symmetrical about the longitudinal axis (L).

2. The clamping ram according to claim 1, characterized in that the radial thickenings (23, 33) widen conically toward the free end (20a, 30a) of the arms (20, 30) at least over an axial portion (25, 35).

3. The clamping ram according to claim 1, characterized in that the contact surfaces (24, 34) are curved.

4. The clamping ram according to claim 1, characterized in that each of the outer surfaces (22, 32) in at least one cross-section is in the form of a circular arc portion (K1, K2) with a radius (R), wherein, in the spread state, the two circular arc portions (K1, K2) lie on an imaginary circle (K) with the radius (R) of the circular arc portions (K1, K2) of this cross-section around the longitudinal axis (L).

5. The clamping ram according to claim 1, characterized in that each of the outer surfaces (22, 32) in any cross-section between the free end (20a, 30a) of the arms (20, 30) and the second end (12b) of the shaft (12) is in the form of a circular arc portion (K1, K2) with a radius (R), wherein, in the spread state, the two circular arc portions (K1, K2) lie on an imaginary circle (K) with the radius (R) of the circular arc portions (K1, K2) of this cross-section around the longitudinal axis (L).

6. The clamping ram according to claim 1, characterized in that each of the arms (20, 30) has on its outer side (22, 32) an auxiliary surface (26, 36) at the end remote from the free end (20a, 30a).

7. The clamping ram according to claim 1, characterized in that the wedge plate (40) is detachable.

8. A set comprising a clamping ram (10) according to claim 1 and a tool or workpiece (80) having a hole (81) with a minimum inner diameter (DL), wherein, in the compressed state, the arms (20, 30) have in the region of the thickenings (23, 33) an outer diameter (DAZ) which is smaller than the minimum inner diameter (DL), and wherein, in the spread state, the arms (20, 30) have in the region of the thickenings (23, 33) an outer diameter (DAg) which is larger than the minimum inner diameter (DL).

9. A method for producing a clamping ram (10) having a shaft (12) with a longitudinal axis (L), a first end (12a) and a second end (12b), wherein at the second end (12b) two arms (20, 30) are arranged which extend in the longitudinal direction and are mutually spaced by a gap (14), wherein each of the arms (20, 30) has an inner surface (21, 31) and an outer surface (22, 32), and wherein at a free end (20a, 30a) of the arms (20, 30) a radial thickening (23, 33) is provided on each outer surface (22, 32), wherein between the two arms (20, 30) a wedge plate (40) is arranged so as to be movable in the longitudinal direction, wherein, in a retracted position of the wedge plate (40), the arms (20, 30) are in a compressed state and, in an advanced position of the wedge plate (40), the arms (20, 30) are in a spread state, comprising the steps of:
providing a clamping ram blank,
producing the outer surface (22, 32) of the arms (20, 30) and the thickenings (23, 33) with the arms (20, 30) in the spread state,
introducing the gap (14) between the arms (20, 30) and
transferring the arms (20, 30) into the compressed state.

10. The method according to claim 9, characterized in that the arms (20, 30) are transferred into the compressed state by pressing or compressing.

11. The method according to claim 9, characterized in that the gap (14) between the arms (20, 30) is introduced using wire cutting or a material-removing method such as milling or water jet cutting.

12. The method according to claim 9, characterized in that the arms (20, 30) are hardened.
